(19) United States
(12) Patent Application Publication
(10) Pub. No.: US 2013/0327417 A1
(43) Pub. Date: Dec. 12, 2013

(54) SELF ALIGNING VENTURI PIPE ASSEMBLY

(71) Applicant: JEFFREY L. GARDNER, Hudson, IA (US)

(72) Inventor: JEFFREY L. GARDNER, Hudson, IA (US)

(21) Appl. No.: 13/490,605

(22) Filed: Jun. 7, 2012

(51) Int. Cl. G05D 11/00

(52) U.S. Cl. 137/115.11

(57) ABSTRACT

An exhaust pipe assembly includes a smaller diameter outlet pipe, a larger diameter outer pipe connected to the outlet pipe by an annular shoulder, and an inlet pipe having a downstream end received by the outlet pipe. The downstream end forms a plurality of ridges separated by grooves. Each groove has an outwardly concave surface which slopes radially inwardly from an inner end to an outer end which includes a bottom end surface. Each ridge has an outer surface which engages an inner surface of the outlet pipe. Exhaust passing from the downstream end of the inlet pipe and though the outlet pipe draws air into the outlet pipe through the grooves due to a venturi effect.

### FIELD

The present disclosure relates to a self aligning venturi pipe assembly.

### BACKGROUND

With the advent of environmental protection agency (EPA) emissions regulations applying to off highway work machines, it is become necessary to employ exhaust after-treatment devices, including diesel particulate filters. Such devices require periodic burning of the accumulated soot particles to prevent clogging of the particulate filter. The process of cleaning such particles, commonly referred to as regeneration, causes a significant increase in the temperature of the exhaust, reaching levels as high as 600 degrees C. This elevated temperature represents a potential problem in the contaminated environment of the work.

Accordingly, a need exists in the art to provide an effective and compact way of cooling the engine exhaust. There is a need to cool exhaust gasses as they flow through the exhaust pipe and exit the tailpipe. Some exhaust systems have included a venturi to draw cooler air into the exhaust stream, and the venturi has a nozzle that free floats inside a pipe. A more rigid pipe assembly is desired.

### SUMMARY

According to an aspect of the present disclosure, an exhaust pipe assembly includes a smaller diameter outlet pipe and a larger diameter outer pipe connected to the outlet pipe by an annular shoulder. The assembly also includes an inlet pipe which has an upstream end for receiving engine exhaust gasses and a downstream end received by the outlet pipe. The downstream end has a downstream edge. The inlet pipe has a main body with a cylindrical outer surface. The downstream end of the inlet pipe forms a plurality of ridges separated by grooves. Each groove has an outwardly concave surface which slopes radially inwardly from an inner end which merges with the cylindrical outer surface to an axially outer end which includes a bottom end surface which is spaced radially inwardly with respect to the cylindrical outer surface. Each ridge has an outer surface which engages an inner surface of the outlet pipe. The annular shoulder is positioned axially between the concave surface inner end and the downstream edge. The main body and the outer pipe form an annular space therebetween. This space has an upstream end which is open to the environment, and the space is communicated with the grooves so that exhaust passing from the downstream end of the inlet pipe and though the outlet pipe draws air into the outlet pipe through the annular space and the grooves due to a venturi effect.

### BRIEF DESCRIPTION OF THE DRAWINGS

FIG. 1 is a side view of the exhaust pipe assembly embodying the invention;

FIG. 2 is a perspective partially cut-away view of the exhaust pipe assembly of FIG. 1;

FIG. 3 is perspective view of an end portion of the inlet pipe of FIG. 1;

FIG. 4 is a view taken along lines 4-4 of FIG. 2; and

FIG. 5 is perspective view of the exhaust pipe assembly of FIG. 1 with the outer pipe removed.

### DETAILED DESCRIPTION OF THE DRAWINGS

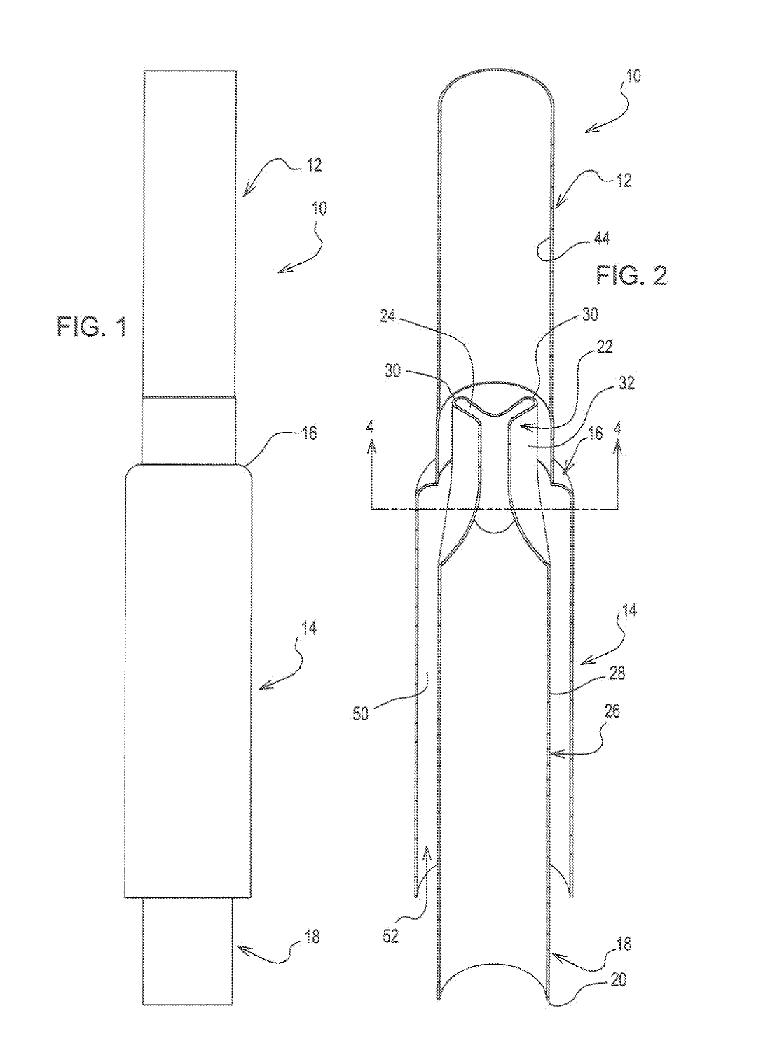

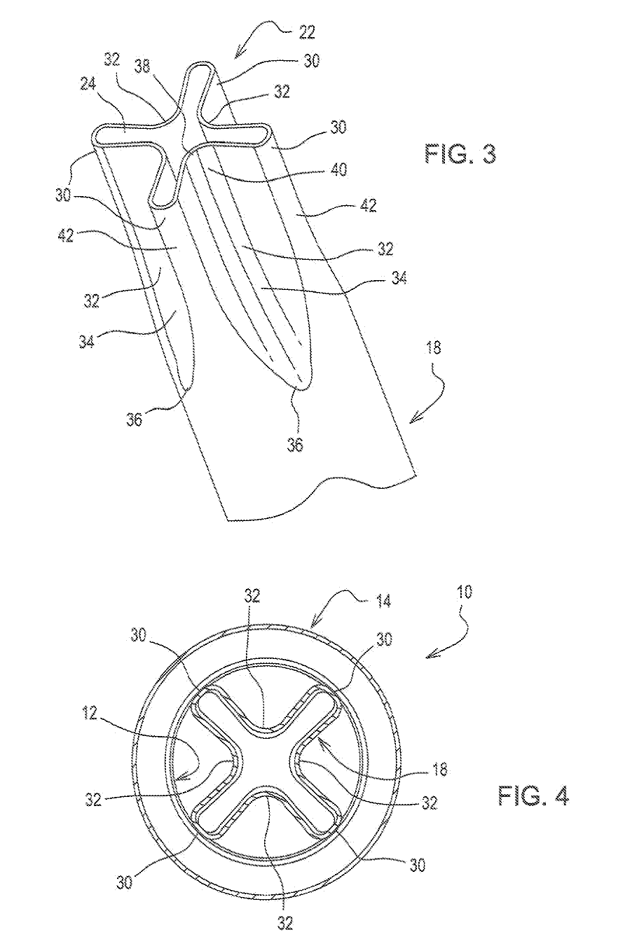

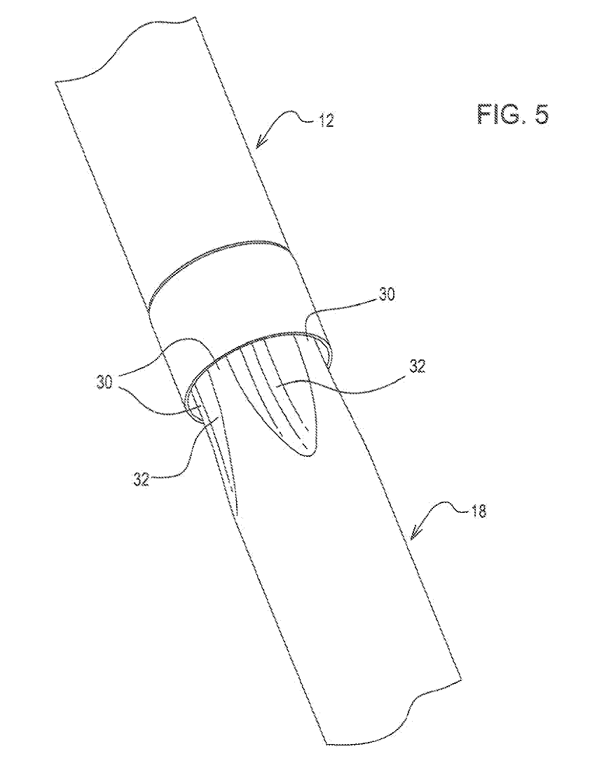

Referring to FIG. 1, an exhaust pipe assembly 10 includes a smaller diameter outlet or first pipe 12, a larger diameter outer or second pipe 14 which is connected to the outlet pipe 12 by an annular shoulder 16, and an inlet or third pipe 18.

The inlet pipe 18 has an upstream end 20 for receiving engine exhaust gasses and has a downstream end portion 22 received by the outlet pipe 12. The downstream end portion 22 has a downstream edge 24. The inlet pipe 18 has a main body 26 which has a cylindrical outer surface 28.

The downstream end portion 22 of the inlet pipe 18 is formed with a plurality of venturi grooves or recesses 32 spaced annularly about the pipe, creating ridges 30 therebetween. Each groove 32 has an outwardly concave surface 34 which slopes radially inwardly from an axially inner end 36 which merges with the cylindrical outer surface 28 to an axially outer end 38 which includes a bottom surface 40 which is spaced radially inwardly with respect to the cylindrical outer surface 28. Each ridge 30 has an outer surface 42 which engages an inner surface 44 of the outlet pipe 12. Preferably, the downstream end portion 22 of the inlet pipe 18 forms four ridges 30 separated by four grooves 32.

The annular shoulder 16 is positioned axially between the concave surface inner end 36 and the downstream end or edge 24 and surrounds a portion of the grooves 32. The main body 26 and the outer pipe 14 form an annular space 50 therebetween. The space 50 has an upstream end 52 which is open to the environment. The space 50 is communicated with the grooves 32 so that exhaust gas flowing from the downstream end 22 of the inlet pipe 18 and though the outlet pipe 12 draws air into the outlet pipe 12 through the annular space 50 and the grooves 32 due to a venturi effect.

The result is a self-aligning and rigidly assembled venturi exhaust pipe assembly 10. The venturi portion forms outer surfaces which engage an outlet pipe during assembly of the structure, and forms valleys for the fresh air to flow through. This assembly 10 is simple to manufacture, self aligning and durable. The venturi portion is concealed by the outer pipe which draws air from a different location.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

I claim:

1. An exhaust pipe assembly comprising:
an outlet pipe;
an inlet pipe having an upstream end for receiving engine exhaust gasses and having a downstream end received by the outlet pipe, said downstream end having a downstream edge, the inlet pipe having a main body having a cylindrical outer surface, the downstream end of the inlet pipe forming a plurality of ridges separated by at least one groove, each groove having an outwardly concave surface which slopes radially inwardly from an inner end which merges with the cylindrical outer surface to an axially outer end which includes a bottom end surface which is spaced radially inwardly with respect to the cylindrical outer surface, and each ridge having an outer surface which engages an inner surface of the outlet pipe, and an interior of the outlet pipe communicating with said grooves so that exhaust gas flowing from the downstream end of the inlet pipe and though the outlet pipe draws air into the outlet pipe through the grooves due to a venturi effect.

2. The exhaust pipe assembly of claim 1, further comprising:
a larger diameter outer pipe connected to the outlet pipe by an annular shoulder.

3. The exhaust pipe assembly of claim 1, wherein:
the annular shoulder is positioned axially between the concave surface inner end and said downstream edge.

4. The exhaust pipe assembly of claim 2, wherein:
the main body and the outer pipe form an annular space therebetween, said space having an upstream end which is open to the environment

5. The exhaust pipe assembly of claim 1, wherein:
the downstream end of the inlet pipe forms four ridges separated by four grooves.

6. An exhaust pipe assembly comprising:
an outlet pipe;
an inlet pipe having an upstream end for receiving engine exhaust gasses and having a downstream end received by the outlet pipe, the inlet pipe having a main body having an outer surface, the downstream end of the inlet pipe forming a plurality of ridges separated by grooves, each groove having an outwardly concave surface which slopes radially inwardly from an inner end which merges with the cylindrical outer surface to an axially outer end, and each ridge having an outer surface which engages an inner surface of the outlet pipe, and an interior of the outlet pipe communicating with said grooves so that exhaust gas flowing from the downstream end of the inlet pipe and though the outlet pipe draws air into the outlet pipe through the grooves due to a venturi effect.

7. The exhaust pipe assembly of claim 6, further comprising:
an outer pipe, the outer pipe having a larger diameter that the diameter of the outlet pipe; and
an annular shoulder connecting the outer pipe to the outlet pipe.

8. The exhaust pipe assembly of claim 7, wherein:
the annular shoulder surrounds a portion of the grooves.

9. An exhaust pipe assembly comprising:
a smaller diameter outlet pipe;
a larger diameter outer pipe connected to the outlet pipe by an annular shoulder; and
an inlet pipe having an upstream end for receiving engine exhaust gasses and having a downstream end received by the outlet pipe, said downstream end having a downstream edge, the inlet pipe having a main body having a cylindrical outer surface, the downstream end of the inlet pipe forming a plurality of ridges separated by grooves, each groove having an outwardly concave surface which slopes radially inwardly from an inner end which merges with the cylindrical outer surface to an axially outer end which includes a bottom end surface which is spaced radially inwardly with respect to the cylindrical outer surface, and each ridge having an outer surface which engages an inner surface of the outlet pipe, the annular shoulder being positioned axially between the concave surface inner end and said downstream edge, the main body and the outer pipe forming an annular space therebetween, said space having an upstream end Which is open to the environment, and said space being communicated with said grooves so that exhaust passing from the downstream end of the inlet pipe and though the outlet pipe draws air into the outlet pipe through the annular space and said grooves due to a venturi effect.
